(19) United States
(12) Patent Application Publication
(10) Pub. No.: US 2021/0203905 A1
(43) Pub. Date: Jul. 1, 2021

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Mitsuru Maeda, Tokyo (JP)

(21) Appl. No.: 17/194,728

(22) Filed: Mar. 8, 2021

Related U.S. Application Data
(63) Continuation of application No. PCT/JP2019/028014, filed on Jul. 17, 2019.

(30) Foreign Application Priority Data
Sep. 14, 2018 (JP) 2018-172675

(51) Int. Cl. H04N 13/178; H04N 13/111; H04N 19/46

(52) U.S. Cl. CPC H04N 13/178; H04N 13/243; H04N 19/46; H04N 13/111

(57) ABSTRACT

The image processing apparatus includes an obtaining unit configured to obtain image data that is derived from at least one of captured images obtained by a plurality of image capturing devices and is used for generating a virtual viewpoint image; and an adding unit configured to add at least one of image capturing setting information, image capturing condition information, image capturing target information, and image capturing right information to the image data obtained by the obtaining unit.

### CROSS-REFERENCE TO RELATED APPLICATIONS

This application is a Continuation of International Patent Application No. PCT/JP2019/028014, filed Jul. 17, 2019, which claims the benefit of Japanese Patent Application No. 2018-172675, filed Sep. 14, 2018, both of which are hereby incorporated by reference herein in their entirety.

### BACKGROUND

### Field

The present disclosure relates to an image processing apparatus that generates a virtual viewpoint video.

### Background Art

Recent years, a technique of generating a virtual viewpoint video by disposing multiple cameras in different positions to perform synchronous shooting from the multiple viewpoints and using multi-viewpoint images obtained by the shooting has been receiving attention. For example, since the technique of generating a virtual viewpoint video from multi-viewpoint images as described above enables viewing of highlight scenes of soccer or basketball from the different angles, it is possible to provide a user with more realistic sensations than general videos do.

NPL 1 discloses a method of synthesizing images of arbitrary viewpoint positions out of images of a target scene shot from multiple viewpoints (cameras). NPL 1 introduces the Model Based Rendering technique. In this technique, a number of cameras are arranged to surround the target as well. With a three-dimensional model being restored by this method, it is possible to synthesize videos from arbitrary viewpoints and also to recreate the positions and motions of players, and thus the technique is also useful for the sports analysis.

### CITATION LIST

### Non Patent Literature

NPL 1: Inamoto et al. 2004. “Fly-Through Observation System for 3D Soccer Movie Based on Viewpoint Interpolation” The Institute of Image Information and Television Engineers Vol. 58, No. 4: 529-539.
NPL 2: Rec. ITU-T H.265 V3 (04/2015)

### SUMMARY

However, since the video data for generating a virtual viewpoint video is managed, stored, and processed in the corresponding devices in the technique disclosed in NPL 1, it is difficult to mutually utilize the video data.

The present disclosure is made in the light of the above-described problem, and an object of the present disclosure is to facilitate the mutual utilization of video data for generating a virtual viewpoint video.

In an embodiment of the present disclosure, an image processing apparatus includes an obtaining unit configured to obtain image data that is derived from at least one of captured images obtained by a plurality of image capturing devices and is used for generating a virtual viewpoint image; and an adding unit configured to add at least one of image capturing setting information, image capturing condition information, image capturing target information, and image capturing right information to the image data obtained by the obtaining unit.

Further features of the present disclosure will become apparent from the following description of exemplary embodiments with reference to the attached drawings.

### BRIEF DESCRIPTION OF THE DRAWINGS

FIG. 1 is a configuration diagram illustrating a configuration example of a system including an image processing apparatus 100 in a first embodiment;

FIG. 2A to FIG. 2D are diagrams illustrating an example of a configuration of an ISO BMFF file in the first embodiment;

FIG. 3 is a diagram illustrating an example of a configuration of an EXIF file in the first embodiment;

FIG. 4 is a diagram showing the relationship of FIG. 4A to FIG. 4C;

FIG. 4A to FIG. 4C are diagrams illustrating an example of a configuration of tag information of FVVI IFD in the first embodiment;

FIG. 5 is a flowchart of video file generating processing in the first embodiment;

FIG. 6 is a flowchart of another video file generating processing in the first embodiment;

FIG. 7 is a configuration diagram illustrating another configuration example of the system including the image processing apparatus 100 in the first embodiment;

FIG. 8 is a configuration diagram illustrating a configuration example of a system including an image processing apparatus 400 in a second embodiment;

FIG. 9 is a diagram illustrating a configuration example of a bit stream of an H.265 encoding method in the second embodiment;

FIG. 10 is a diagram illustrating a configuration example of VUI Parameters, which is vui_parameters( ), in the second embodiment;

FIG. 11 is a diagram illustrating a configuration example of an SEI message, which is sei_payload( ), in the second embodiment;

FIG. 12 is a diagram illustrating a configuration example of free_viewpoint_video_info(payloadSize) in the second embodiment;

FIG. 13 is a diagram illustrating a configuration example of free_viewpoint_video_info(payloadSize) in the second embodiment;

FIG. 14 is a diagram illustrating a configuration example of free_viewpoint_video_info(payloadSize) in the second embodiment;

FIG. 15 is a diagram illustrating a configuration example of free_viewpoint_video_info(payloadSize) in the second embodiment;

FIG. 16 is a diagram illustrating an example of a configuration of PPS in the second embodiment;

FIG. 17 is a diagram illustrating details of pic_free_viewpoint_info( ) in the second embodiment;

FIG. 18 is a diagram illustrating details of pic_free_viewpoint_info( ) in the second embodiment;

FIG. 19 is a diagram illustrating details of pic_free_viewpoint_info( ) in the second embodiment;

FIG. 20 is a flowchart illustrating bit stream generating processing in the second embodiment;

FIG. 21 is a configuration diagram illustrating a configuration example of a system including an image processing apparatus 500 in a third embodiment;

FIG. 22 is a diagram illustrating an example of a display screen in the third embodiment; and

FIG. 23 is a block diagram illustrating a hardware configuration example of a computer that is applicable to the image processing apparatus of each embodiment.

### DESCRIPTION OF THE EMBODIMENTS

Hereinafter, embodiments of the present disclosure are described in detail with reference to the appended drawings. Note that, the configurations described in the following embodiments are merely examples, and the present disclosure is not limited to the illustrated configurations.

### First Embodiment

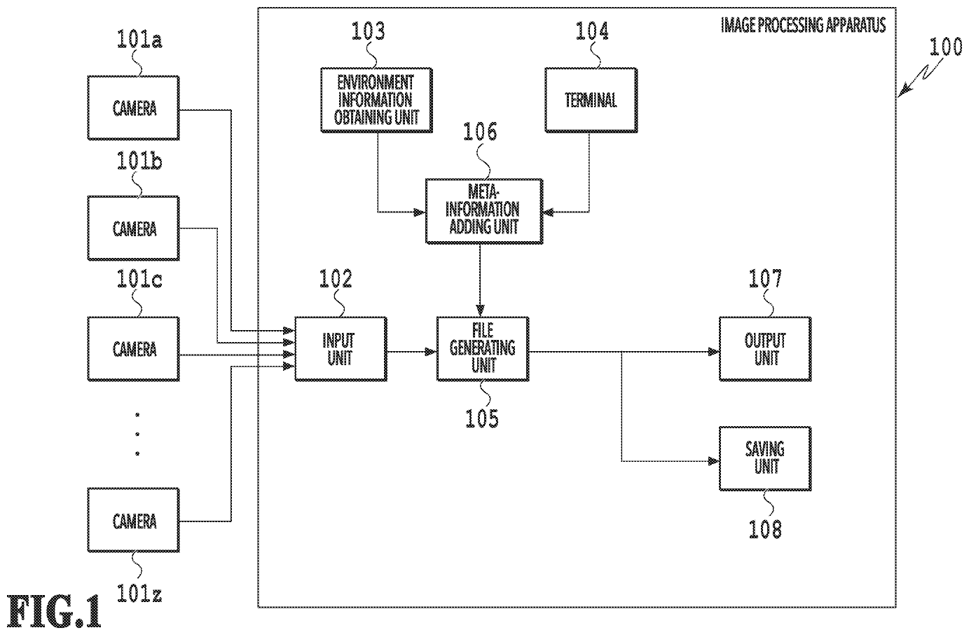

FIG. 1 illustrates a configuration example of a system including an image processing apparatus 100 in a first embodiment. In this system, multiple cameras (image capturing devices) are disposed in a facility such as a playing field (stadium) and a concert hall to perform shooting (image capturing).

The image processing apparatus 100 includes cameras 101a to z, an input unit 102, an environment information obtaining unit 103, a terminal 104, a file generating unit 105, a meta-information adding unit 106, an output unit 107, and a saving unit 108.

The cameras 101a to 101z are arranged to surround an object and perform the shooting synchronously. Note that, the number and the arrangement of the cameras are not limited. The cameras 101a to 101z are connected to the input unit 102 of the image processing apparatus 100 through a network.

The input unit 102 receives inputs of video data shot by the cameras 101a to 101z and outputs the video data to the file generating unit 105.

The terminal 104 receives an input of meta-information on the video data from a user and outputs the inputted meta-information to the meta-information adding unit 106. The inputted meta-information contains at least one of shooting setting information, shooting condition information, shooting target information, and shooting right information, for example. Details of the meta-information are described later.

The environment information obtaining unit 103 includes a sensor or the like that obtains environment information to, for example, obtain information on climate and the like on the day of the shooting and outputs the information to the meta-information adding unit 106. Note that, the method of obtaining the environment information is not limited thereto, and the environment information may be obtained from the outside through the Internet or the like, for example.

The file generating unit 105 adds header data required for filing to the inputted video data and generates a video file. Hereinafter, standards of ISO/IEC 14496-12 (MPEG-4 Part 12) ISO base media format (hereinafter, ISO BMFF) are used as an example to describe the format of the video file. Note that, the format of the video file is not limited thereto.

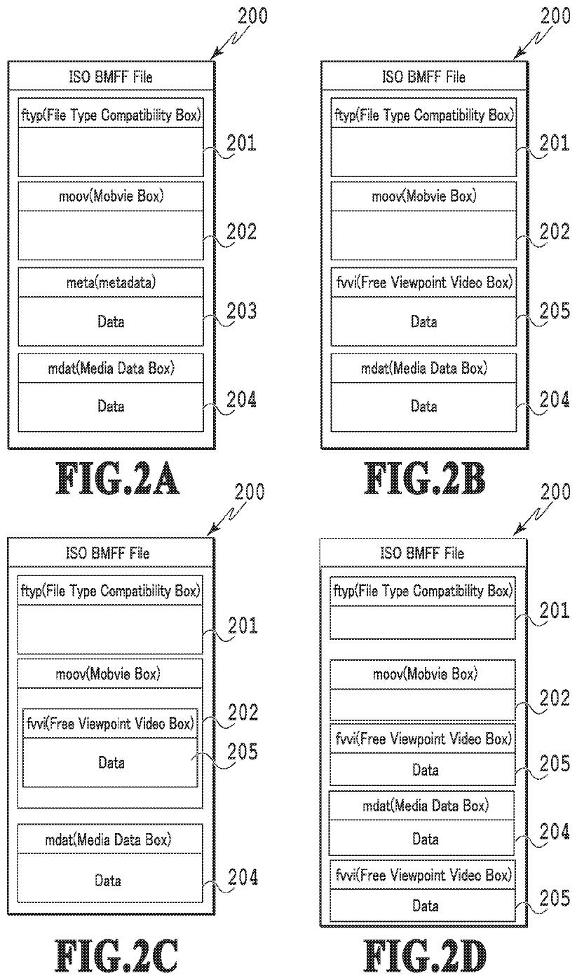

FIG. 2A to FIG. 2D illustrate a configuration example of the ISO BMFF file in this embodiment.

In FIG. 2A, an ISO BMFF file 200 contains boxes of flyp (File Type Compatibility Box) 201 and moov (Movie Box) 202. Additionally, the ISO BMFF file 200 contains boxes of meta (metadata) 203 and mdat (Media Data Box) 204. The box flyp 201 contains information on a file format that describes, for example, that the file is an ISO BMFF file, and the version of the box, the name of the maker who created the video file, and so on. The box moov 202 contains information such as a time axis and an address for managing the media data (video data). The box meta 203 contains the meta-information of the video data. The meta-information contained in the box meta 203 is described later. The box mdat 204 contains media data (video data) that is to be actually reproduced as a moving image.

Referring back to FIG. 1, the meta-information adding unit 106 generates the box meta 203 that indicates the meta-information based on the information received from the environment information obtaining unit 103 and the terminal 104. The file generating unit 105 can add the meta-information to the video file by using the box meta 203. A configuration example of the box meta 203 is shown below.

```
aligned(8) class MetaBox (handler_type)extends FullBox(‘meta‘,
version = 0, 0) {
  HandlerBox(handler_type) theHandler;
  PrimaryItemBox primary_resource; // optional
  DatainInformationBox file_locations; // optional
  ItemLocationBox item_locations; // optional
  ItemProtectionBox protections; // optional
  ItemInfoBox item_infos; // optional
  IPMPControlBox IPMP_control; // optional
  ItemReferenceBox item_refs; // optional
  ItemDataBox item_data; // optional
  Filming_scene_information; // optional
  Filming_condition; // optional
  Filming_object; // optional
  Filming_right_holder // option'
  Box other_boxes[ ]; // optional
}
```

Filming_scene_information indicates the shooting setting information, Filming_condition indicates the shooting condition information, Filming_object indicates the shooting target information, and Filming_right_holder indicates the shooting right information.

A configuration of the Filming_scene_information box that indicates the shooting setting information is shown below.

Box Type: ‘ffsi’
Container: Meta box (‘meta’)

### Mandatory: No

### Quantity: Zero or one

Additionally, the syntax is shown below.

```
  aligned(8) class ItemLocationBox extends FullBox(‘ffsi‘,
version,0) {
  unsigned int(32) offset_size;
  unsigned int(32) length_size;
  unsigned int(32) base_offset_size;
  if (version == 1)
    unsigned int(32) index_size;
  else
    unsigned int(32) reserved;
  unsigned int(16)num_free_viewpoint_original_video_info;
  for (i=0; i<num_free_viewpoint_original_video_info; i++)
    unsigned char(8) free_viewpoint_original_video_info[i];
  unsigned int(32) category_code;
  unsigned int(64) filming_date_time_code;
  unsigned int(16) num_char_place_name;
  for (i=0; i<num_char_place_name;i++)
    unsigned char(8) place_name
  unsigned int(16) num_char_convention_name;
  for (i=0; i<num_char_convention_name;i++)
    unsigned char(8) convention_name[i];
  unsigned int(16) num_char_event_name;
  for (i=0; i<num_char_event_name;i++)
    unsigned char(8) event_name[i];
  unsigned int(16) num_char_stage_name;
  for (i=0; i<num_char_stage_name;i++)
    unsigned char(8) stage_name[i];
  unsigned int(16) num_char_stage_name;
  for (i=0; i<num_char_place_name;i++)
    unsigned char(8) place_name[i];
  unsigned char(8) free_viewpoint_filming_info_code
  if (free_viewpoint_filming_info_code && 0x01) {  //
existence or non-existence of system
    unsigned int(16) num_ char_filming_system_info_minus1;
    for (i=0; i<=num_char_filming_system_info_minus1;i++)
    unsigned char(8) filming_system_information[i];
  } // existence or non-existence of system
  if (free_viewpoint_filming_info_code && 0x02) { // 0x02
    unsigned int(16) max_num_target_point_minus1;
    unsigned int(16) num_target.__point_minus1;
    for (i=0; i<=num_target_point_minust;i++) { // target point
    unsigned int(16) target_point_name_length;
    for (j=0; j<target_point_name_length;j++)
      unsigned char(8) targetpoint_name[i][j];
    for 0=0; j<3)
      signed int(16) target_point_location[i][j];
    unsigned int(16) num_camera_minus1;
    unsigned int(16) max_camera_name_length;
    unsigned int(16) camera_name_length;
    for (j =0; j<=num_camera_minus1;j++) { // camera
      for (k=0; k<camera_name_length;k++)
      unsigned in t(16) camera_name[i][j][k];
      for (k=0; k<3)
      unsigned int(16) camera_location[i][j][k];
      for (k=0; k<4)
      unsigned int(16) camera_atitude[i][j][k];
      unsigned int(16) num_char_camera_type_info;
      for (k=0; k<num_char_camera_type;k++)
      unsigned char(8) camera_type_information[i][j][k];
      unsigned int(16) num_char_lenz_type_info;
      for (k=0; k<num_char_lenz_type;k++)
      unsigned char(8) lenz_type_information[i][j][k];
      unsigned int(16) focus_distance[i][j];
    } // camera
    } // target point
  } // 0x02
  }
```

In the above syntax, offset_size, length_size, base_offset_size, index_size, and reserved are described in the written standards of the above-mentioned standards and are codes related to the size and the like of the box.

num_free_viewpoint_original_video_info is a code that indicates a length of a character string of information on the video data and the like required for generating the virtual viewpoint video. free_viewpoint_original_video_info is an array for storing a character string of information on material data.

category_code is a code that indicates the target of the shooting and indicates a category of the purpose of the shooting such as sports, entertainment, and monitoring. For example, sports is 0x0001, and entertainment is 0x0002.

filming_date_time_code is a code that indicates the date and time of the shooting and indicates the start time and the like of the shooting. The date and time of the shooting is indicated by the format of W3C-DTF, for example. The date and time of the shooting is expressed in Christian year, month, day, time, minute, second, and millisecond, for example. The date and time of the shooting is expressed in the time difference from the UTC (coordinated universal time=Greenwich standard time), for example. filming_date_time_code is a code as a bit string that is an integration of the above-described bit string indicating the date and time of the shooting and a preliminary bit added thereto.

num_char_place_name is a code that indicates a length of a character string indicating the place of the shooting. place_name is a character string that indicates the name of the place of the shooting and is a character string such as “Tokyo Soccer Stadium”, for example. Note that, the information on the place of the shooting is not limited to a character string. Additionally, a code for indicating the language may be added.

num_char_convemtion_name is a code that indicates a length of a character string indicating a brief summary of the shooting, that is, the name and the like of a tournament or a speech. convention_name is a character string that indicates the name of the event to be shot and is a character string such as “the xxx-th Olympic Games”, for example. Note that, the information on the event to be shot is not limited to a character string. Additionally, a code for indicating the language may be added.

num_char_event_name is a code that indicates a length of a character string of information on details of the contents of the shooting. The details of the contents of the shooting are categories of the contents such as a competition event or musical and concert, for example. event_name is a character string that indicates the details of the contents of the shooting and is a character string such as “soccer”, “table tennis”, “100 m backstroke”. “musical”, “concert”, and “magic show”, for example.

num_char_stage_name is a code that indicates a length of a character string of information on details of a stage of the target of the shooting. stage_name is a character string indicating the details of the stage of the shooting and is a character string such as “preliminary round”, “first round”, “semifinal”, “final”, “rehearsal”, “real performance”, and “the xx-th speech”, for example.

free_viewpoint_filming_info_code is a code that indicates information on a shooting system and the like. For example, in a case where the first bit is 1, it is indicated that there is information on the shooting system, and in a case where the second bit is 1, it is indicated that there is information on the camera.

num_char_filming_system_info_minus1 is a code that indicates a length of a character string indicating the name of the shooting system. filming_system_information is a character string that indicates the name of the shooting system.

max_num_target_point_minus1 is a value that indicates the maximum value of the number of target points to which the cameras used in this shooting system are directed. num_target_point_minus1 is a code that indicates the number of the target points to which the cameras used in this shooting system are directed.

target_point_name_length is a code that indicates a length of a character string indicating the name or the like for identifying the target points. Ina case where the name or the like for identifying the target points is not set, the length of the character string is set to 0. target_point_name indicates the name or the like for identifying each of the target points.

target_point_location is a code for expressing the positions of the target points in three-dimensional coordinates.

num_camera_minus1 is a code that indicates the number of the cameras used in this shooting system. max_camera_namelength is a code that indicates the maximum value of a length of a character string for adding the name or the like for identifying each of the cameras. camera_name_length is a code that indicates a length of a character string indicating the name or the like for identifying the camera. camera_name indicates the name or the like for identifying the camera. Otherwise, camera_name may simply be a number for identifying the camera.

camera_location indicates the position of the camera as a three-dimensional position. camera_attitude is a code that indicates an orientation of the camera.

num_char_camera_type_info is a code that indicates a length of a character string indicating information on the camera itself that is, for example, the company name and the model name. camera_type_information is a character string that indicates the information on the camera itself that is, for example, the company name and the model name.

num_char_lenz_type_info is a code that indicates a length of a character string indicating information on a lens mounted in the camera that is, for example, the company name and the model name. lenz_type_information is a character string that indicates the information on the lens itself that is, for example, the company name and the model name. focus_distance is a code that indicates a focal length for indicating an angle of view of the lens during the shooting.

Next, a configuration of the Filming_condition box that indicates the shooting condition information is shown below.

Box Type: ‘ffci’
Container: Meta box (‘meta’)

### Mandatory: No

### Quantity: Zero or one

Additionally, the syntax is shown below.

```
aligned(8) class ItemLocationBox extends FullBox(‘ffci‘,
version,0) {
unsigned int(32) offset_size;
unsigned int(32) length_size;
unsigned int(32) base_offset_size;
if (version == 1)
  unsigned int(32) index_size;
else
  unsigned int(32) reserved;
unsigned int(8) room_code;
signed int(16) illuminant_code;
if (illuminant_code > 0) {
  if (illutninant_code == 1){
  unsigned int(16) sun_direction;
  unsigned int(8) sun_altituude;
  }
  unsigned int(32) weather_code;
  signed int(16) templature C_value;
  unsigned int(8) humidity_value;
  unsigned int(8) wind_direction;
  unsigned int(8) wind_force;
}
}
```

In the above syntax, room_code is a code that indicates information on a location such as indoor or outdoor. For example, in a case where the value is 0, it is indicated that the condition is unknown. In a case where the value is 1, it is indicated that the location is outdoor, in a case where the value is 2, it is indicated that the location is a dome, and in a case where the value is 3, it is indicated that the location is indoor.

illuminant_code is a code that indicates information on a light source. For example, in a case where it is sunlight, the value is set to 1. In a case of indoor illuminations such as a fluorescent, the code is allocated to each of the light sources. In a case where the value is 0, it is indicated that there is no information on the light source.

sun_direction is a code that indicates a direction of the sun (light source). For example, sun_direction may be a value that expresses the orientation in 360 degrees while setting 0 for the north. sun_altituude is a value that indicates an altitude of the sun. For example, sun_altituude may be expressed in an angle with respect to the horizontal direction.

weather_code is a code that indicates weather. For example, in a case where the value is 0, it is indicated that it is sunny, and the values from 1 to 10 may indicate the amount of cloud. Additionally, information such as rain and snow may be allocated to the greater digits.

templature_C_value indicates the temperature and is expressed in Celsius, for example. Additionally, it is possible to discriminate cases where the temperature is measured and not measured by setting the value to 0xFFFF in the case where the temperature is not measured. humidity_value expresses the humidity in %.

wind_direction indicates a wind direction and may be, for example, a value that expresses the orientation in 360 degrees while setting 0 for the north. wind_force is a value that indicates a wind force. Otherwise, wind_force may indicate a wind speed.

Next, a configuration of the Filming_object box that indicates the shooting target information is shown below.

Box Type: ‘ffoi’
Container: Meta box (‘meta’)

### Mandatory: No

### Quantity: Zero or one

Additionally, the syntax is shown below.

aligned(8) class ItemLocationBox extends FullBox(‘ffoi‘,version,0) {
unsigned int(32) offset_size:
unsigned int(32) length_size;
unsigned int(32) base_offset_size;
if (version == 1)
unsigned int(32) index size;
else
unsigned int(32) reserved;
unsigned int (16) max_num_object;
unsigned int(16) num_object;
for (i=0; i<=num_object;i++) {
unsigned int(16) num_char_object_info;
for (j=0; j<num_char_object_info j++)
unsigned char(8) object_information[j][i];
}
}

In the above syntax, max_num_object is a value that indicates the maximum value of the number of the shot targets. num_object is the number of the actually shot targets in the unit of frame, the unit of video clip, and the unit of the whole video.

num_char_object_info is a value that indicates a length of a character string indicating the target. object_information is a character string that indicates the target.

Next, a configuration of the Filming_right_holder box that indicates the shooting right information is shown below.

Box Type: ‘ffri’
Container: Meta box (‘meta’)

### Mandatory: No

### Quantity: Zero or one

Additionally, the syntax is shown below.

```
  aligned(8) class ItemLocationBox extends FullBox(‘ffri‘,version,0) {
  unsigned int(32) offset_size;
  unsigned int(32) length_size;
  unsigned int(32) base_offset_size;
  if (version == 1)
  unsigned int(32) index_size;
  else
  unsigned int(32) reserved;
  unsigned int(16) max_num_right_holder;
  unsigned int(16) num_right_holder;
  for (i=0 i<num_right_holder; i++) {
  unsigned int(16) num_char_right_holder;
  for (j=0; j<num_char_right_holder_info;j++)
  unsigned char(8) right_holder_information[i][j]
  }
}
```

In the above syntax, max_num_right_holder is a value that indicates the maximum value of the number of individuals and institutions who have the rights related to the shooting (hereinafter called right holders, collectively). num_right_holder is the number of the right holders who actually have the rights in the unit of frame, the unit of video clip, and the unit of the whole video.

num_char_right_holder is a value that indicates a length of a character string indicating the name or the like of the right holder.

right_holder_information is a character string that indicates the name or the like of the right holder.

As described above, the file generating unit 105 can add the meta-information to the ISO BMFF file 200 by using the box meta 203 generated by the meta-information adding unit 106.

Additionally, as illustrated in FIG. 2B, a new dedicated box may be provided instead of the general box meta 203. For example, a new box type such as an fvvi (Free Viewpoint Video Info) 205 may be provided.

The above-mentioned box fvvi 205 can be added to the whole video (sequence), to each video clip including multiple frames, or to each frame. That is, as illustrated in FIG. 2C, the box fvvi 205 may be added to the box moov 202. In a case where an additional box moov is contained in the box moov 202, the box fvvi 205 may be added to the box moov inside. Additionally, as illustrated in FIG. 2D, the box fvvi 205 may be divided in multiple pieces to be added.

Referring back to FIG. 1, the output unit 107 outputs the video file to which the meta-information is added to the outside. The saving unit 108 saves the video file to which the meta-information is added in a storage medium.

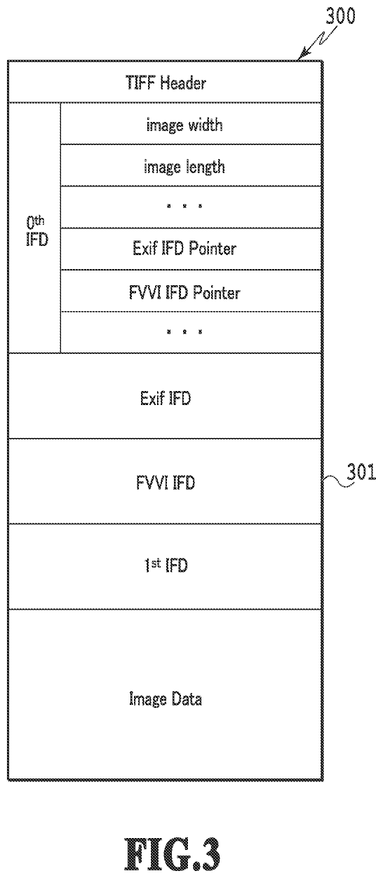

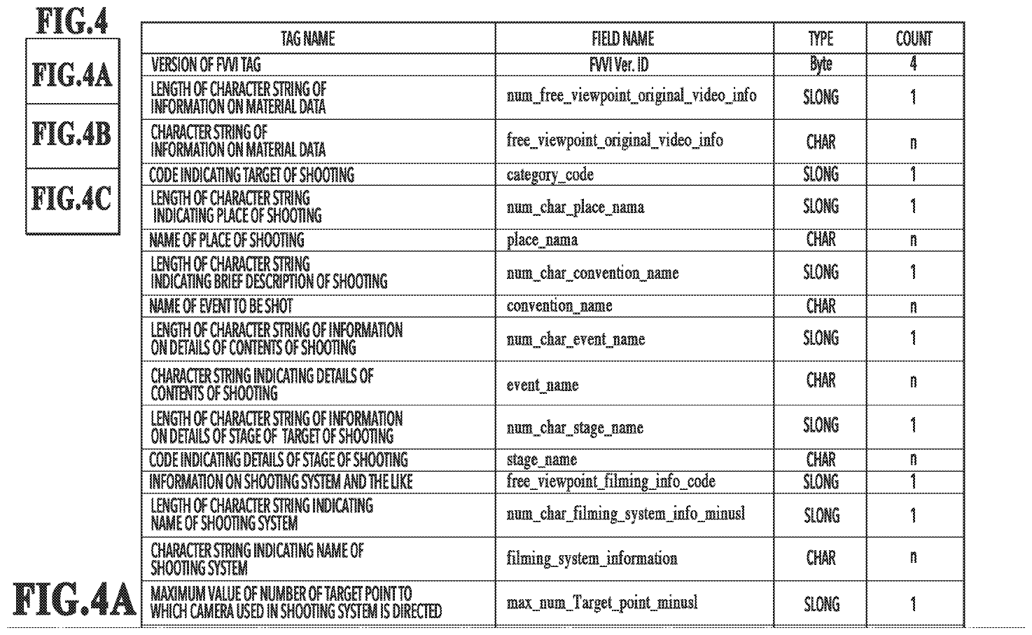

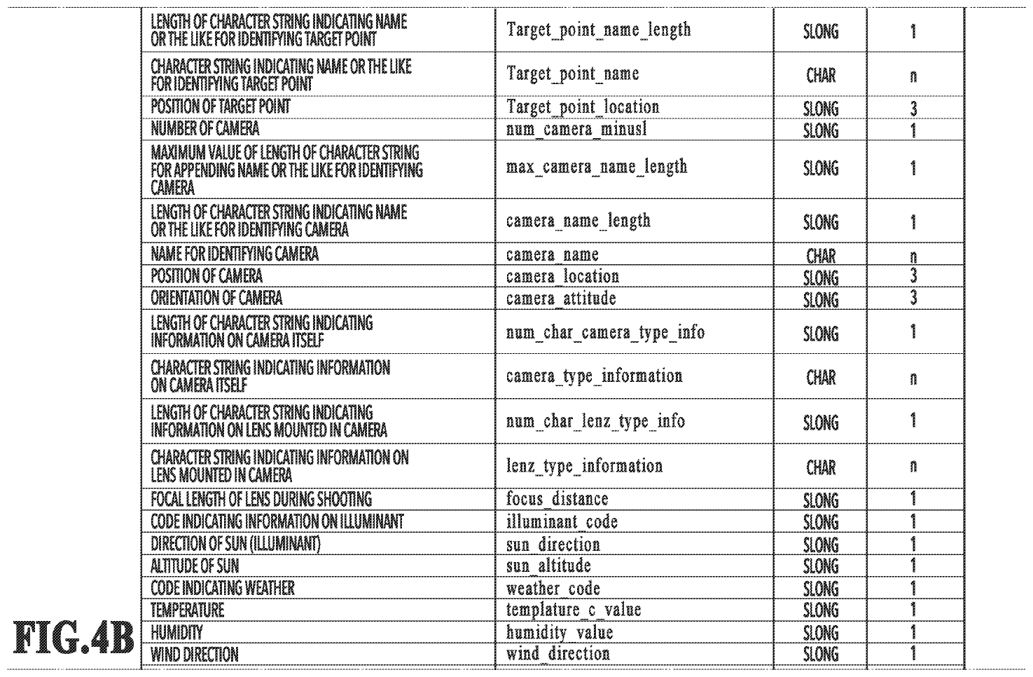

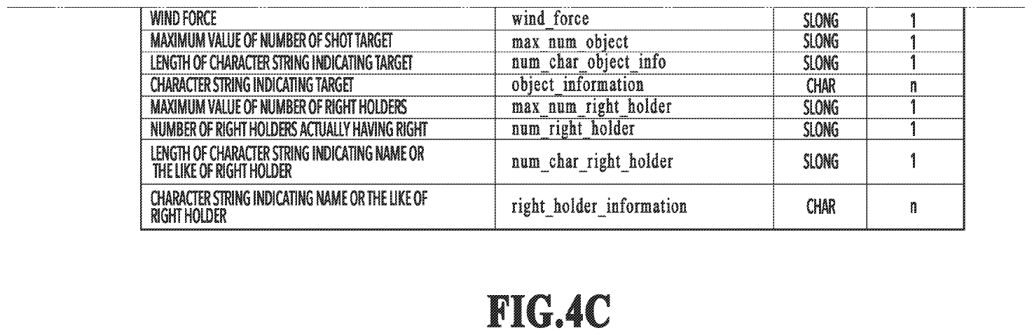

Note that, the file format is not limited to the ISO BMFF. For example, use of “Camera and Imaging Products Association Standards DC-008-2012 digital still camera image file format standards Exif2.3” (hereinafter, Exif standard) for storing a still image may be possible. FIG. 3 illustrates an example of a format of a file using the Exif standard in this embodiment (EXIF file). In a file format 300, the meta-information on the virtual viewpoint video (virtual viewpoint image) is defined as a Free Viewpoint Video Information Image File Directory (hereinafter, FVVI IFD) 301. The FVVI IFD 301 stores the shooting setting information, the shooting condition information, the shooting target information, and the shooting right information. FIG. 4A to FIG. 4C illustrate an example of a configuration of tag information of the FVVI IFD 301 in this embodiment. In the FVVI IFD 301, the codes of the above-described ISO BMFF are stored in the respective tags.

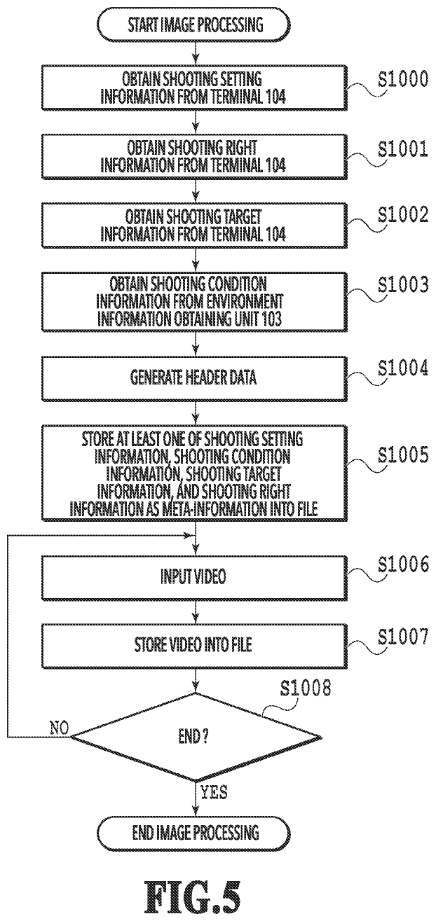

FIG. 5 illustrates a flowchart of video file generating processing in this embodiment. A series of processing indicated in the flowchart is performed with a CPU 801 of the image processing apparatus 100 reading out a control program stored in a ROM 803 to a RAM 802 and executing the control program, as described later. Otherwise, functions of some of or all the steps in the flowchart may be implemented by hardware such as an ASIC and an electronic circuit. A sign “S” in the description of each processing means a step in the flowchart. The same applies to other flowcharts as well.

First, in S1000, the meta-information adding unit 106 obtains the shooting setting information that is inputted by the user from the terminal 104. The shooting setting information includes at least one of the place of the shooting, the date and time of the shooting, the contents of the event, and the camera information. Additionally, the camera information includes at least one of the position of the target point of the camera, the number of the cameras, the arrangement of the camera, the orientation of the camera, and the focal length.

In S1001, the meta-information adding unit 106 obtains the shooting right information that is inputted by the user from the terminal 104. The shooting right information includes information on the right holder related to the shooting.

In S1002, the meta-information adding unit 106 obtains the shooting target information that is inputted by the user from the terminal 104. The shooting target information includes information on the target to be shot that is, for example, the player's name and role in the team. That is, the shooting target information includes at least one of the name of the target to be shot and the name of the target group.

In S1003, the meta-information adding unit 106 obtains the shooting condition information obtained by the environment information obtaining unit 103, which is the information of light source, temperature, humidity, wind direction, and wind force, for example, from the environment information obtaining unit 103. That is, the shooting condition information includes the climate information during the shooting.

Note that, the order from S1000 to S1003 is not limited, and an arbitrary order may be applied. Additionally, the meta-information adding unit 106 may obtain at least one of the shooting setting information, the shooting right information, the shooting target information, and the shooting condition information with at least one of the steps of S1000 to S1003 being executed.

In S1004, the file generating unit 105 generates the header data of the video file. For example, the file generating unit 105 generates the box flyp 201 in the ISO BMFF and generates 0^{th}IFD in the Exif. The generated header data is inputted to the meta-information adding unit 106 and is stored in the file by the file generating unit 105.

In S1005, the meta-information adding unit 106 adds at least one of the obtained shooting setting information, shooting right information, shooting target information, and shooting condition information to the file as the meta-information. The file generating unit 105 stores the added meta-information into the file. Note that, the meta-information is added by using the box meta and the box ffvi in the ISO BMFF. The meta-information is added by using the FVVI IFD in the Exif.

In S1006, the input unit 102 receives the inputs of the video data from the cameras 101a to 101z and inputs the video data to the file generating unit 105.

In S1007, the file generating unit 105 stores the video data inputted through the input unit 102 into the file. For example, in the ISO BMFF, the file generating unit 105 identifies the video data as the box mdat and adds a required code to store the video data into the file. In the Exif, the file generating unit 105 identifies the video data as Image Data and stores the video data into the file. Additionally, the file into which the video data is stored is outputted to the outside by the output unit 107 or saved in the saving unit 108. Note that, the file generating unit 105 may encode the video data.

In S1008, once the inputting of the video data from the cameras 101a to 101z is terminated or once an instruction of terminating the processing is inputted from the terminal 104, the processing is terminated. Otherwise, the process returns to S1006, and the next video data is processed.

The video file generating processing in this embodiment is performed as described above. According to this embodiment, it is possible to use the ISO BMFF and the Exif to add the meta-information to the video data and generate the video file.

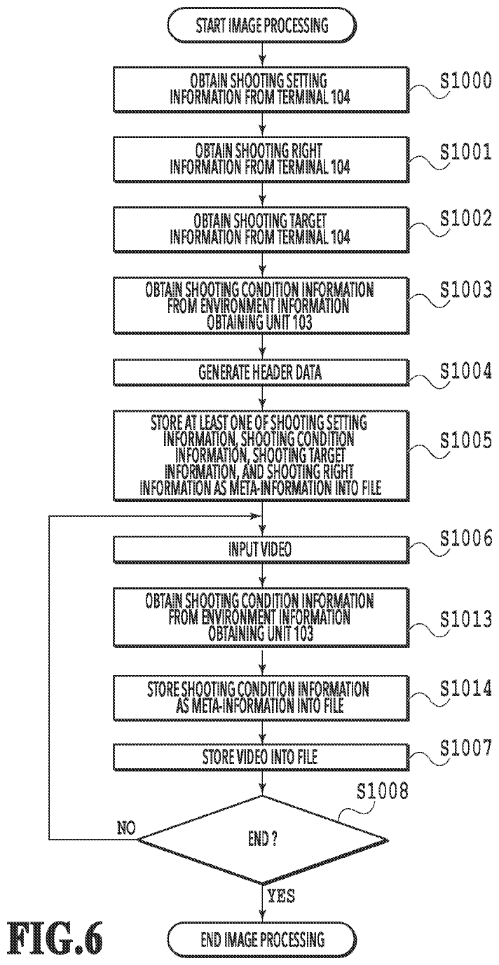

FIG. 6 illustrates a flowchart of another video file generating processing in this embodiment. Hereinafter, an example where shooting condition information that changes over time is added to the video data by the unit of frame is described. Note that, the steps in which the same processing as that in the steps in the flowchart in FIG. 5 are marked with the same numbers, and detailed descriptions are omitted.

In the flowchart of FIG. 6, once the input unit 102 outputs the video data to the file generating unit 105 in S1006, the process proceeds to S1013.

In S1013, the meta-information adding unit 106 obtains the shooting condition information that is, for example, light source, temperature, humidity, wind direction, and wind force from the environment information obtaining unit 103.

In S1014, the meta-information adding unit 106 generates the meta-information based on the obtained shooting condition information and adds the meta-information to the video file. In the ISO BMFF, the meta-information can be added to the video file by using the box meta and the box ffvi. In the Exif the meta-information can be added by using the FVVI IFD.

Thus, in the video file generating processing illustrated in FIG. 6, it is possible to add the shooting condition information changed over time by the unit of frame. Additionally, another meta-information may be added by the unit of frame as well. For example, in a system in which the camera moves by following the object, the target point is moved accordingly, and this motion can be added as the shooting setting information to the video file. Moreover, the shooting target information may be limited to the target shot in the video and added by the unit of frame.

As described above, according to this embodiment, it is possible to mutually utilize the generated video files as a common video file and to add at least one of the shooting setting information, the shooting right information, the shooting target information, and the shooting condition information as the meta-information. Thus, it is possible to search and obtain the video data efficiently.

Note that, the image processing apparatus 100 in this embodiment is not limited to the physical configuration described in FIG. 1 and may have a logical configuration.

Additionally, in this embodiment, the data may be encrypted to be saved. This case may include a code for determining whether the data is encrypted.

Moreover, in this embodiment, the file generating unit 105 may obtain information on the disposing of the camera out of the shooting setting information from, for example, each of the cameras 101a to 101z through the input unit 102 with the video data and a number such as an ID of the camera.

Furthermore, although the file generating unit 105 stores the inputted video data directly into the file in this embodiment, the video data may be stored after being encoded.

Additionally, although the meta-information adding unit 106 stores the inputted meta-information directly into the file in this embodiment, the meta-information may be stored after being encoded.

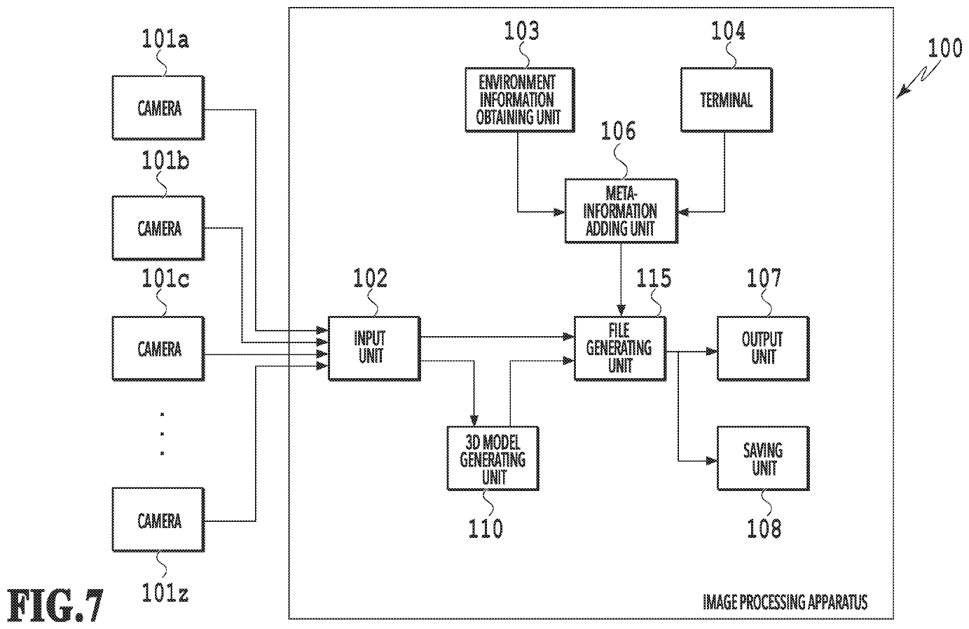

Moreover, as illustrated in FIG. 7, the meta-information may be added to a video file on which processing required for generating the virtual viewpoint video is performed by a 3D model generating unit 110. Note that, in FIG. 7, constituents similar to that in FIG. 1 are marked with the same numbers, and the descriptions thereof are omitted. For example, the 3D model generating unit 110 generates a 3D model by cutting out a region in which the target is captured from the multiple pieces of video data that are inputted from the input unit 102. A file generating unit 115 adds the 3D model obtained from the 3D model generating unit 110 to the video file in addition to the video data inputted from the input unit 102. Additionally, the file generating unit 115 obtains the meta-information (shooting target information) in the unit of 3D model from the meta-information adding unit 105 and adds the meta-information to the video file. Thus, in this embodiment, it is possible to multiplex and display the shooting target information easily during generating and displaying of the virtual viewpoint video even in the case of using the 3D model.

### Second Embodiment

In the second embodiment, image processing in which video data is searched for by using meta-information and a virtual viewpoint video (virtual viewpoint image) is generated by using the search result is described.

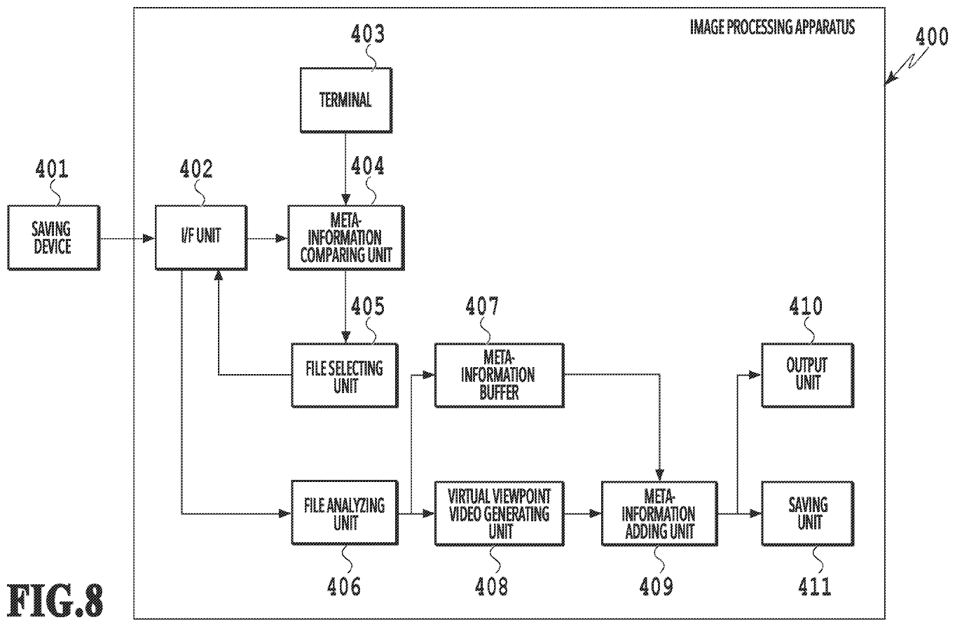

FIG. 8 illustrates a configuration example of a system including an image processing apparatus 400 in this embodiment. The image processing apparatus 400 is connected to an external saving device 401. The saving device 401 stores a video file to which the meta-information is added, as with the saving unit 108 illustrated in FIG. 1 in the first embodiment, for example. For the sake of easy description, an example where a video file is described in the ISO BMFF is used to describe this embodiment.

The image processing apparatus 40 includes an interface (I/F) unit 402, a terminal 403, a meta-information comparing unit 404, and a file selecting unit 405. Additionally, the image processing apparatus 400 includes a file analyzing unit 406, a meta-information buffer 407, a virtual viewpoint video generating unit 408, a meta-information adding unit 409, an output unit 410, and a saving unit 411. The image processing apparatus 40 reads out desired video data from the saving device 401 to generate a virtual viewpoint video.

The terminal 403 receives an input of a search condition related to the video data for generating the virtual viewpoint video from the user. The terminal 403 receives a keyword such as “data on the final of the ◯◯ tournament” as the search condition, for example. The terminal 403 inputs the received keyword to the meta-information comparing unit 404.

Once the terminal 403 indicates that the searching is started, the I/F unit 402 reads out the data of the box meta 203 (that is, meta-information) by the unit of video file from header data of the video file stored in the saving device 401. The read data of the box meta 203 is inputted to the meta-information comparing unit 404.

The meta-information comparing unit 404 compares the meta-information inputted from the I/F unit 402 with the keyword inputted from the terminal 403. In a case where there is meta-information that matches the keyword, the meta-information comparing unit 404 notifies the file selecting unit 405 of information on the video file containing the meta-information that is, for example, a file path and a file name.

The file selecting unit 405 selects a video file to be used for generating the virtual viewpoint video based on the notified video file information and accesses the saving device 401 through the I/F unit 402. The saving device 401 reads out the selected video file in response to the access and inputs the video file to the file analyzing unit 406 through the I/F unit 402.

The file analyzing unit 406 analyzes the inputted video file, separates the meta-information from the video file, stores the separated meta-information into the meta-information buffer 407, and inputs the video data required for generating the virtual viewpoint video to the virtual viewpoint video generating unit 408.

The virtual viewpoint video generating unit 408 uses the inputted video data to generate a video from a virtual viewpoint designated by the user (that is, virtual viewpoint video). The virtual viewpoint video generating unit 408 encodes the generated virtual viewpoint video. Although an example of using the H.265 encoding method for the encoding is described herein, the method is not limited thereto. For example, encoding methods such as H.264 and MPEG-1, 2, and 4 may be used. In the case of MPEG-1, 2, and 4, for example, the data may be stored in user_data( ), and a new header may be defined. A bit stream of the virtual viewpoint video encoded by the H.265 encoding method is inputted to the meta-information adding unit 409.

The meta-information adding unit 409 reads out the meta-information of original video data stored in the meta-information buffer 407 and adds the meta-information to the inputted bit stream. Additionally, for the adding, the meta-information adding unit 409 adds meta-information indicating that the generated video file (bit stream) is the virtual viewpoint video. Moreover, the meta-information adding unit 409 can add information on a system that generates the virtual viewpoint video and information on a right holder of the system as well.

The output unit 410 outputs the bit stream of the virtual viewpoint video to which the meta-information is added to the outside. The saving unit 411 saves the bit stream of the virtual viewpoint video to which the meta-information is added in the storage medium.

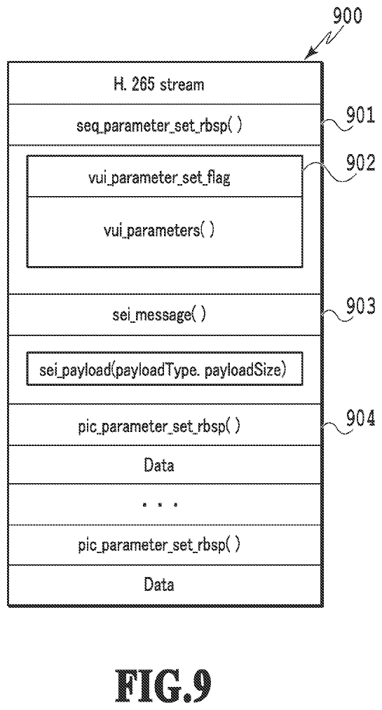

FIG. 9 is a diagram illustrating a configuration example of a bit stream 900 encoded by the H.265 encoding method in this embodiment.

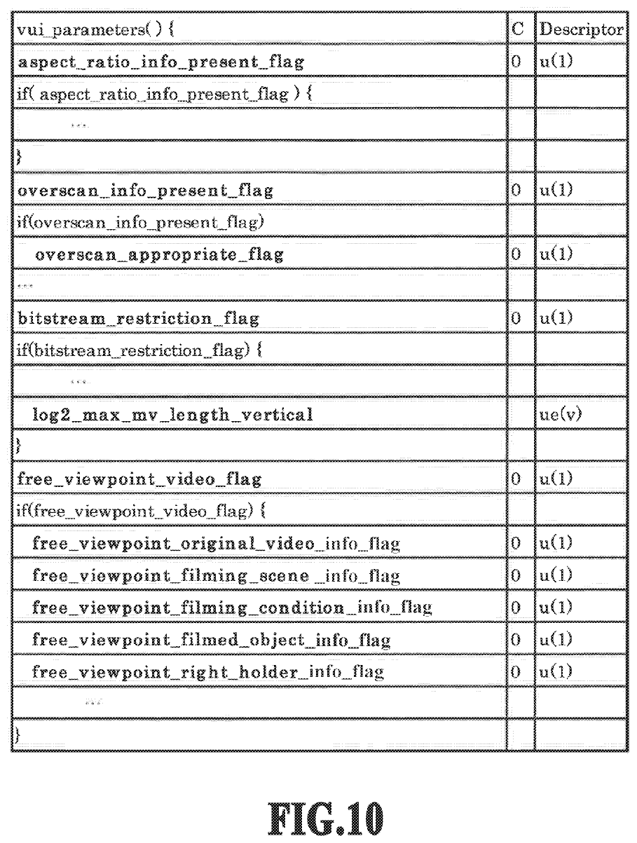

The bit stream 900 contains a sequence header (seq_parameter_set_rbsp( ), hereinafter SPS) 901 that indicates a whole sequence at the top. The SPS 901 contains VUI (Video Usability Information) Parameters 902 that add convenient information to an image. FIG. 10 illustrates vui_parameters), which is a configuration example of the VUI Parameters 902 in this embodiment. Note that, detailed descriptions of an aspect_ratio_info_present_flg code to log 2_max_mv_length_verticalcode are omitted since they are described in NPL 2. In this embodiment, the codes below are added following the log 2_max_mv_length_vertical code.

A free_viewpoint_video_flag code is a flag that indicates whether the bit stream is the virtual viewpoint video. In a case where the value is 1, it is indicated that the video of the bit stream is the virtual viewpoint video, and in a case where the value is 0, it is indicated that the bit stream is a video shot by a general camera or the like. Note that, in a case of a bit stream to which this embodiment is not applied, this flag does not exist, and thus the value is 0 in this case.

A free_viewpoint_original_video_info_flag code is a flag that indicates whether there is video data as an original material of the generated virtual viewpoint video of the bit stream. In a case where the value is 1, it is indicated that there is the video data as the material of the generated virtual viewpoint video of the bit stream, and in a case where the value is 0, it is indicated that there is no video data as the material or that it is inaccessible to the video data.

A free_viewpoint_filming_scene_info_flag code is a flag that indicates whether there is the meta-information of the shooting setting information related to the setting of the case of shooting the video data as the original material of the generated virtual viewpoint video of the bit stream. In a case where the value is 1, it is indicated that the shooting setting information, which is in the case of shooting the video data as the original material of the generated virtual viewpoint video of the bit stream, exists as the meta-information. Ina case where the value is 0, it is indicated that the meta-information does not exist.

A free_viewpoint_filming_condition_info_flag code is a flag that indicates whether there is the meta-information of the shooting condition information related to the condition of the case of shooting the video data as the original material of the generated virtual viewpoint video of the bit stream. In a case where the value is 1, it is indicated that the shooting condition information, which is in the case of shooting the video data as the original material of the generated virtual viewpoint video of the bit stream, exists as the meta-information. In a case where the value is 0, it is indicated that the meta-information does not exist.

A free_viewpoint_filmed_object_info_flag code is a flag that indicates whether there is the meta-information of the shooting target information related to the target in the case of shooting the video data as the original material of the generated virtual viewpoint video of the bit stream. In a case where the value is 1, it is indicated that the shooting target information, which is in the case of shooting the video data as the original material of the generated virtual viewpoint video of the bit stream, exists as the meta-information. In a case where the value is 0, it is indicated that the meta-information does not exist.

A free_viewpoint_right_holder_info_flag code is a flag that indicates whether there is the meta-information of the shooting right information related to the right holder in the case of shooting the video data as the original material of the generated virtual viewpoint video of the bit stream. In a case where the value is 1, it is indicated that the shooting right information, which is in the case of shooting the video data as the original material of the generated virtual viewpoint video of the bit stream, exists as the meta-information. Ina case where the value is 0, it is indicated that the meta-information does not exist.

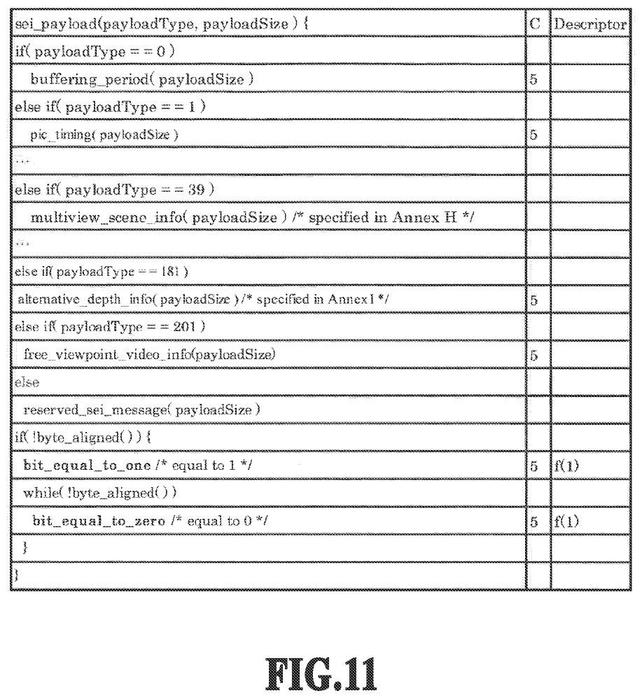

Referring back to FIG. 9, the bit stream 900 in this embodiment can further contain a supplemental enhancement information (hereinafter, abbreviated as SEI) message 903. FIG. 11 illustrates sei_payload( ), which is a configuration example of the SEI message 903 in this embodiment. The contents are determined based on the type (payloadType) and the size (payloadSize) of the SEI message 903. Note that, refer to NPL 2 chapter 7.3.5 Supplemental enhancement information message syntax for details of the contents to alternative_depth_info (payloadSize).

In this embodiment, payloadType of the meta-information is defined as “201”. In the case where payloadType is “201”, the meta-information of the size indicated by payloadSize is read out according to free_viewpoint_video_info(payloadSize).

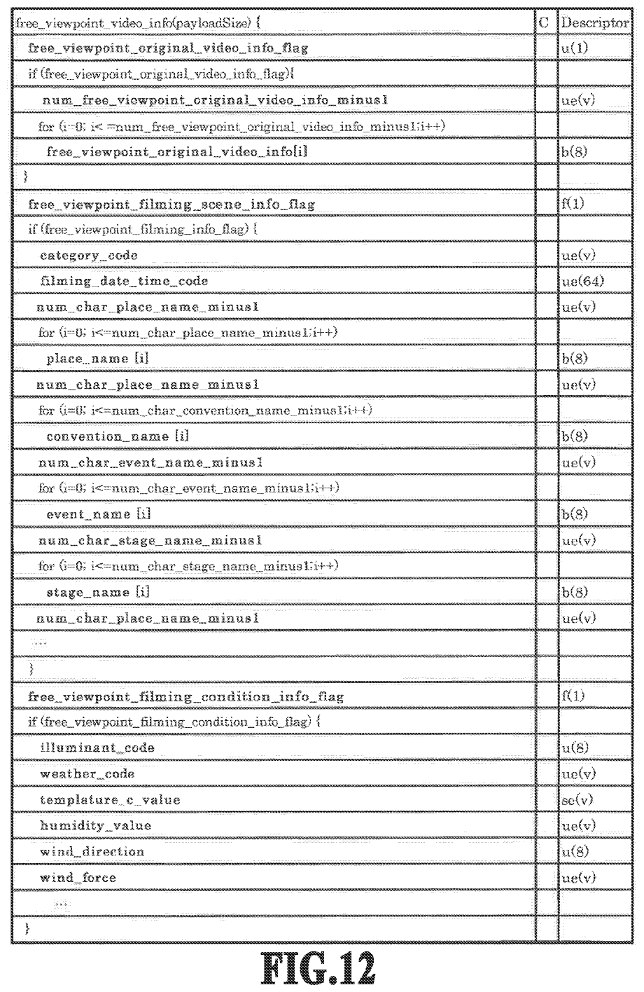

FIGS. 12 to 15 illustrate configuration examples of free_viewpoint_video_info(payloadSize). Since the codes same as the codes described in the ISO BMFF have the similar meanings in this embodiment, the detailed descriptions are omitted.

FIG. 12 illustrates the following codes, which are some of the codes of free_viewpoint_video_info(payloadSize).

A free_viewpoint_original_video_info_flag code functions similarly as the code of the above-described VUI Parameters 902 with the same name illustrated in FIG. 10 does. In a case where the value is 1, it is indicated that there is the video data as the original material of the generated virtual viewpoint video of the bit stream, and in a case where the value is 0, it is indicated that there is no video data as the material or that it is inaccessible to the video data. In a case where the value is 0, a num_free_viewpoint_original_video_info_minus1 code and a free_viewpoint_original_video_info code are omitted.

A free_viewpoint_filming_scene_info_flag code functions similarly as the code of the above-described VUI Parameters 902 with the same name illustrated in FIG. 10 does. In a case where the value is 1, it is indicated that there is the meta-information of the shooting setting information related to the setting of the case of shooting the video data as the original material of the generated virtual viewpoint video of the bit stream. In a case where the value is 0, subsequent category_code and the following shooting setting information do not exist. Note that, in FIG. 12, for the sake of simplifying the drawing, meta-information of the shooting setting information following num_char_place_name_minus1 is omitted.

A free_viewpoint_filming_condition_info_flag code functions similarly as the code of the above-described VUI Parameters 902 with the same name illustrated in FIG. 10 does. In a case where the value is 1, it is indicated that there is the meta-information of the shooting condition information related to the condition of the case of shooting the video data as the original material of the generated virtual viewpoint video of the bit stream. In a case where the value is 0, subsequent illuminant_code and the following shooting condition information do not exist.

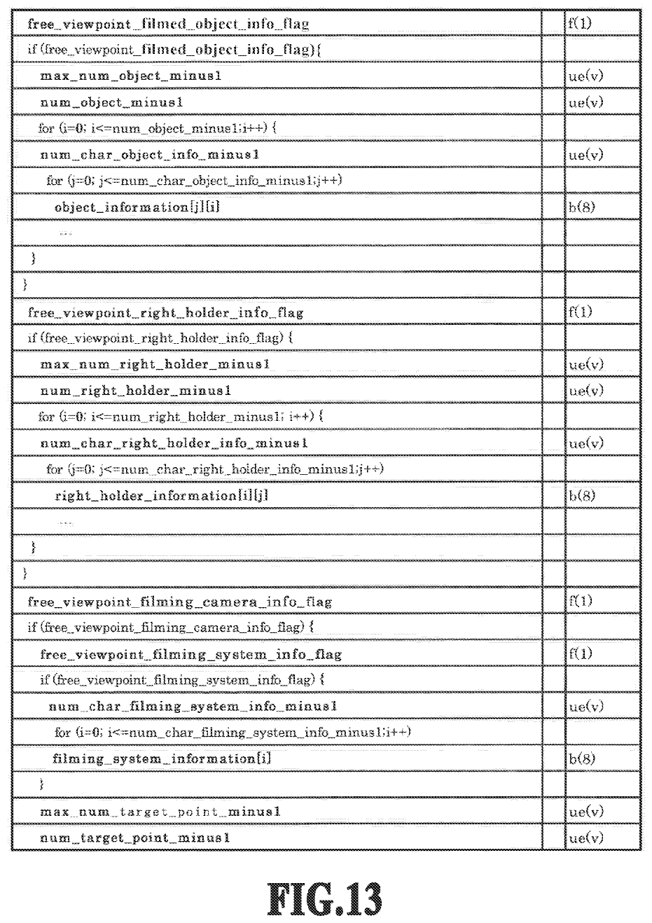

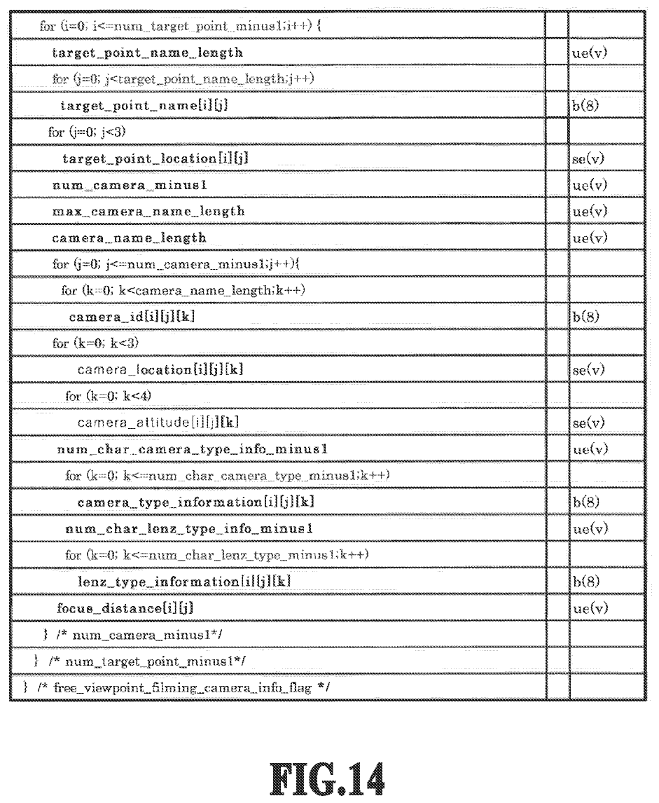

FIGS. 13 and 14 illustrate the following codes, which are some of the codes of free_viewpoint_video_info(payloadSize) that follow the codes illustrated in FIG. 12.

A free_viewpoint_filmed_object_info_flag code functions similarly as the code of the above-described VUI Parameters 902 with the same name illustrated in FIG. 10 does. In a case where the value is 1, it is indicated that there is the meta-information of the shooting target information related to the target in the case of shooting the video data as the original material of the generated virtual viewpoint video of the bit stream. In a case where the value is 0, subsequent max_num_object_minus1 and the following shooting target information do not exist. Note that, in FIG. 13, for the sake of simplifying the drawing, meta-information of the shooting target information following object_information is omitted.

A free_viewpoint_filming_right_holder_info_flag code functions similarly as the code of the above-described VUI Parameters 902 with the same name illustrated in FIG. 10 does. In a case where the value is 1, it is indicated that there is the meta-information of the shooting right information related to the right holder in the case of shooting the video data as the original material of the generated virtual viewpoint video of the bit stream. Ina case where the value is 0, subsequent max_num_right_holder_minus1 and the following shooting right information do not exist.

A free_viewpoint_filming_camera_info_flag code is a flag that indicates whether there is the meta-information of the shooting setting information related to the setting of the camera in the case of shooting the video data as the material of the generated virtual viewpoint video of the bit stream. In a case where the value is 1, it is indicated that the shooting setting information related to the setting of the camera, which is in the case of shooting the video data as the original material of the generated virtual viewpoint video of the bit stream, exists as the meta-information. In a case where the value is 0, it is indicated that the meta-information does not exist. That is, free_viewpoint_filming_system_info_flag and the following codes do not exist.

The free_viewpoint_filming_system_info_flag code is a flag that indicates whether there is the meta-information of the shooting setting information related to the system in the case of shooting the video data as the material of the generated virtual viewpoint video of the bit stream. In a case where the value is 1, it is indicated that the shooting setting information related to the system which is in the case of shooting the video data as the original material of the generated virtual viewpoint video of the bit stream, exists as the meta-information. In a case where the value is 0, it is indicated that the meta-information does not exist. That is, num_char_filming_system_info_minus1 and the following codes do not exist.

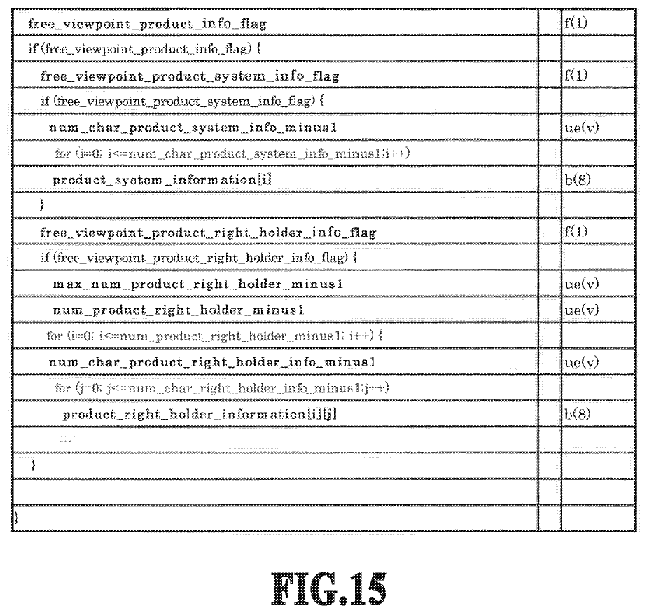

FIG. 15 illustrates the following codes, which are some of the codes of free_viewpoint_video_info(payloadSize) that follow the codes illustrated in FIG. 14.

A free_viewpoint_product_info_flag code is a flag that indicates whether there is meta-information of generation setting information related to the case where the virtual viewpoint video of the bit stream is generated. The generation setting information contains information on a generated system and a right holder of the generated video data; however, the information is not limited thereto. In a case where the value is 1, it is indicated that the generation setting information, which is in the case of generating the virtual viewpoint video of the bit stream, exists as the meta-information. In a case where the value is 0, it is indicated that the meta-information does not exist. That is, free_viewpoint_product_system_info_flag and the following codes do not exist.

The free_viewpoint_product_system_info_flag code is a flag that indicates whether there is meta-information related to a system used in the case of generating the virtual viewpoint video of the bit stream. In a case where the value is 1, it is indicated that the generation system information, which is in the case of generating the virtual viewpoint video of the bit stream, exists as the meta-information. In a case where the value is 0, it is indicated that the meta-information does not exist. That is, num_char_product_system_info_minus1 and the following codes do not exist.

num_char_product_system_info_minus1 is a code that indicates a length of a character string indicating the name of the system that generates the virtual viewpoint video.

product_system_information indicates the name of the system that generates the virtual viewpoint video. Note that, the information on the system that generates the virtual viewpoint video is not limited to the name and may be a model number or a version.

A free_viewpoint_product_right_holder_info_flag code is a flag that indicates whether there is meta-information of generation right information related to a right holder in the case of generating the virtual viewpoint video of the bit stream. In a case where the value is 1, it is indicated that the meta-information of the generation right information related to the right holder, which is in the case of generating the virtual viewpoint video of the bit stream, exists. In a case where the value is 0, subsequent max_num_product_right_holder_minus1 and the following generation right information do not exist.

max_num_product_right_holder_minus1 is a value that indicates the maximum value of the number of the right holders having the right related to the virtual viewpoint video generation. num_product_right_holder_minus1 indicates the number of the right holders actually having the right in the unit of frame, the unit of video clip, or the unit of whole video.

num_char_product_right_holder_info_minus1 is a value that indicates a length of a character string indicating the name or the like of the right holder related to the virtual viewpoint video generation.

product_right_holder_information indicates the character string indicating the name or the like of the right holder related to the virtual viewpoint video generation.

Referring back to FIG. 9, codes of the video data of the actual virtual viewpoint video are contained subsequently, and the bit stream is completed.

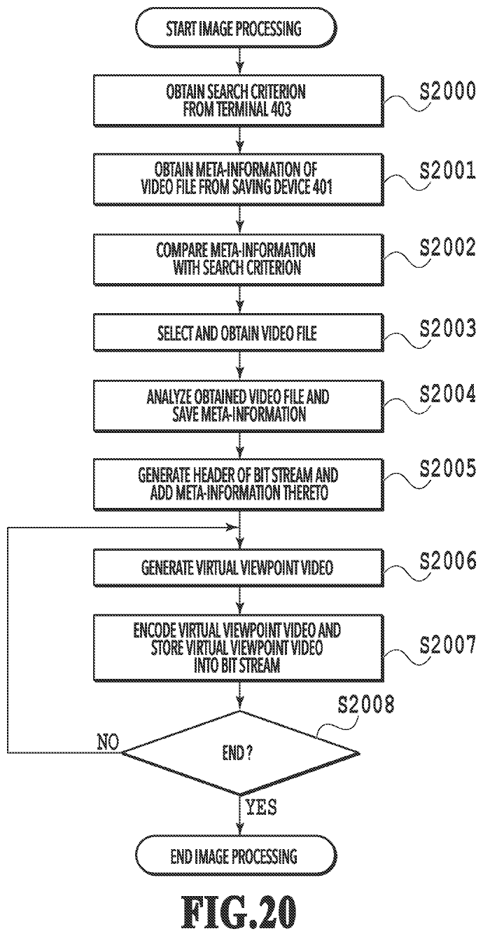

FIG. 20 illustrates a flowchart of bit stream generating processing in this embodiment.

In S2000, the meta-information comparing unit 404 obtains the keyword that is the search condition inputted by the user from the terminal 403.

In S2001, the I/F unit 402 obtains the data of the box meta 203 (that is, meta-information) by the unit of video file from the header data of the video file stored in the saving device 401. The obtained data is inputted to the meta-information comparing unit 404.

In S2002, the meta-information comparing unit 404 compares the meta-information inputted from the I/F unit 402 with the keyword (that is, search condition) obtained from the terminal 403. In a case where there is the meta-information that matches the keyword, the meta-information comparing unit 404 notifies the file selecting unit 405 of the information on the video file containing the meta-information.

In S2003, the file selecting unit 405 selects the video file to be used for generating the virtual viewpoint video based on the notified video file information and accesses the saving device 401 through the I/F unit 402. The saving device 401 reads out the selected video file in response to the access and inputs the video file to the file analyzing unit 406 through the I/F unit 402.

In S2004, the file analyzing unit 406 analyzes the inputted video file, separates the meta-information from the video file, and stores the separated meta-information into the meta-information buffer 407. Additionally, the file analyzing unit 406 inputs the video data of the inputted video file to the virtual viewpoint video generating unit 408.

In S2005, the meta-information adding unit 409 reads out the meta-information of the original video stored in the meta-information buffer 407 and adds the meta-information to the header of the bit stream.

In S2006, the virtual viewpoint video generating unit 408 generates the video (that is, virtual viewpoint video) from the virtual viewpoint designated by the user and the like.

In S2007, the virtual viewpoint video generating unit 408 encodes the generated virtual viewpoint video and stores the virtual viewpoint video into the bit stream.

In S2008, once the inputting of the video data is terminated or once an instruction of terminating the processing is inputted from the terminal 403, the processing is terminated. Otherwise, the process returns to S2006, and the next video data is processed.

As described above, according to this embodiment, it is possible to enable the mutual utilization of the virtual viewpoint video as a common bit stream and to add at least one of the shooting setting information, the shooting right information, the shooting target information, and the shooting condition information as the meta-information. This makes it possible to efficiently search for and obtain the virtual viewpoint video. Additionally, it is also possible to implement a function of searching for the virtual viewpoint video by adding the information indicating whether the bit stream is the virtual viewpoint video.

Note that, in a case of reading out multiple video files from the saving device 401 and generating the virtual viewpoint video, the respective pieces of meta-information may be added to the virtual viewpoint videos corresponding to the video files, or the pieces of meta-information of the multiple video files may be integrated and added as a single piece of meta-information.

Additionally, it is possible to add the meta-information by the unit of frame as illustrated in the flowchart of FIG. 6 in the first embodiment. For example, it is possible to add the information indicating whether the video data is the virtual viewpoint video to a header of a picture indicating the unit of frame.

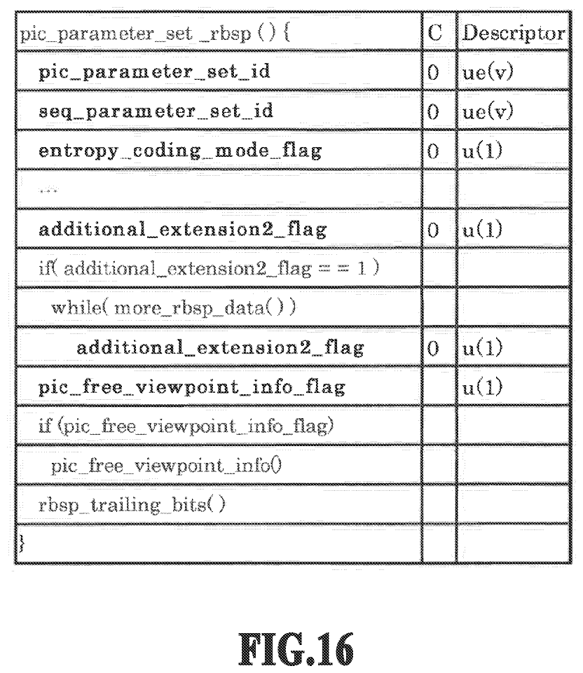

Referring back to FIG. 9, the bit stream 900 in this embodiment may contain a header of a picture (pic_parameter_set_rbsp( ), hereinafter PPS) 904. FIG. 16 illustrates an example of a configuration of the PPS 904 in this embodiment.

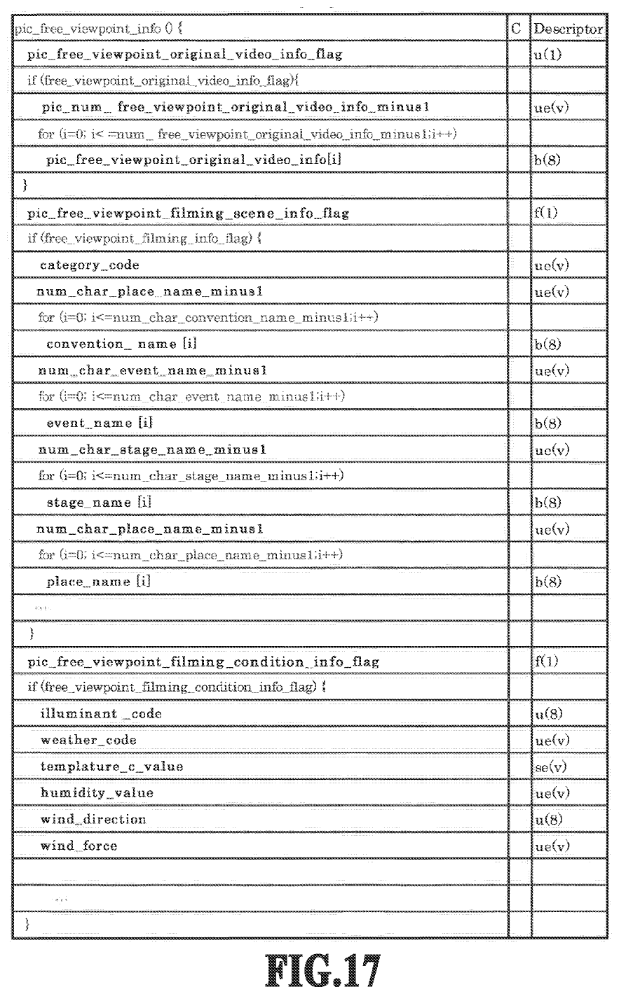

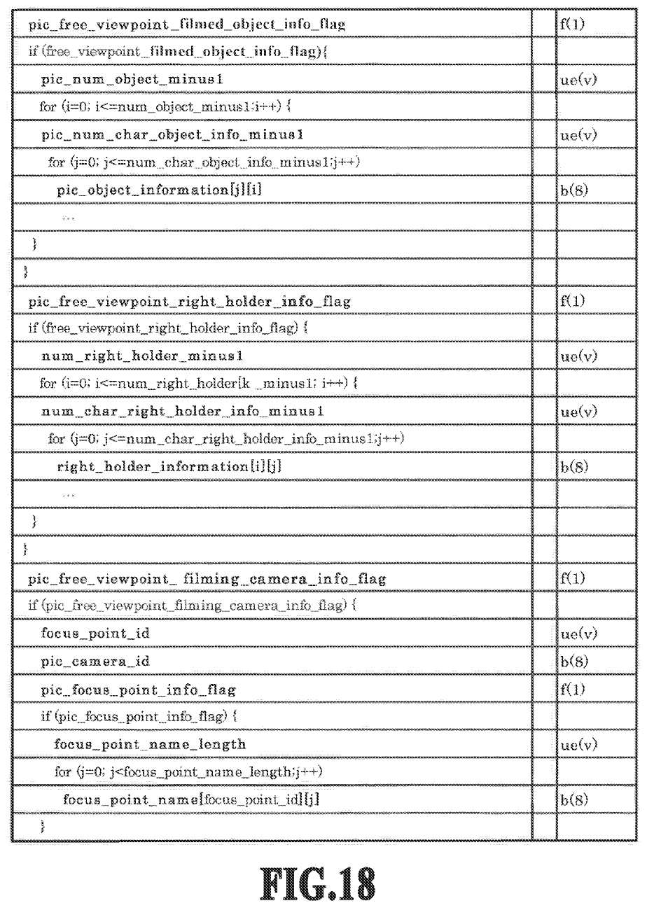

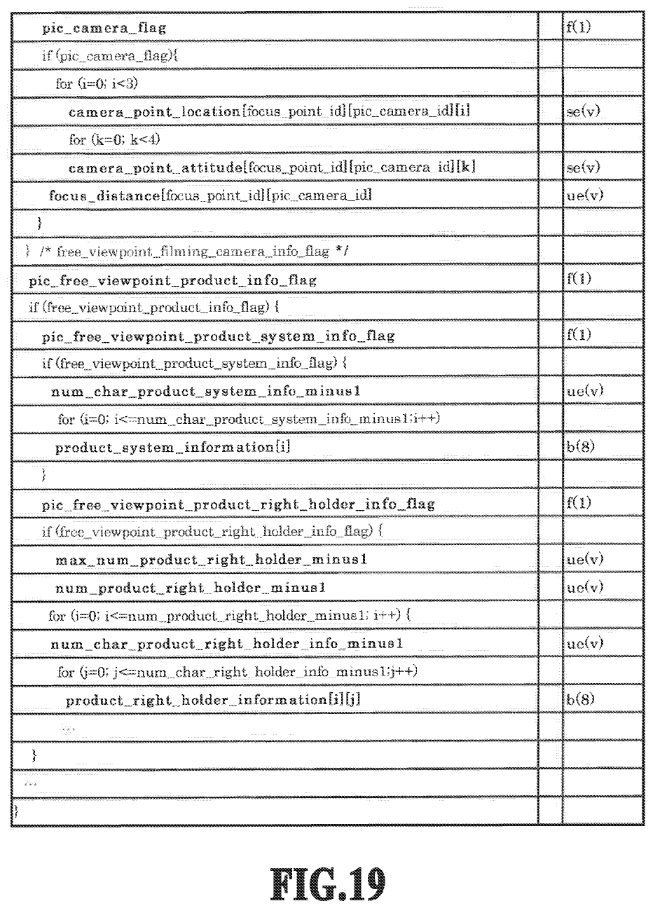

A pic_free_viewpoint_info_flag code indicates whether there is the meta-information related to the shooting and the generating of the virtual viewpoint video by the unit of picture. In a case where the value is 1, it is indicated that the meta-information related to the shooting and the generating of the virtual viewpoint video is contained in pic_free_viewpoint_info( ). FIGS. 17 to 19 illustrate details of pic_free_viewpoint_info( ) in this embodiment. Basically, like the contents of FIGS. 12 to 15 that can be set by the unit of frame, a prefix of pic_is added to a flag that requires determination by the unit of frame, and the same contents are encoded to be added to the bit stream. Thus, it is possible to update the meta-information by the unit of frame.

Additionally, the pic_free_viewpoint_info_flag code added to each frame may be integrated by the unit such as a sequence or a chapter including multiple frames to be included in the part of the VUI parameter. In this case, in a case where a part of the sequence is the virtual viewpoint video, it is possible to obtain the information without decoding each frame.

Moreover, the bit stream may be stored into the box mdat to constitute the ISO BMFF file.

### Third Embodiment

In this embodiment, an image processing apparatus that searches for the bit stream by using the meta-information and displays the search result is described.

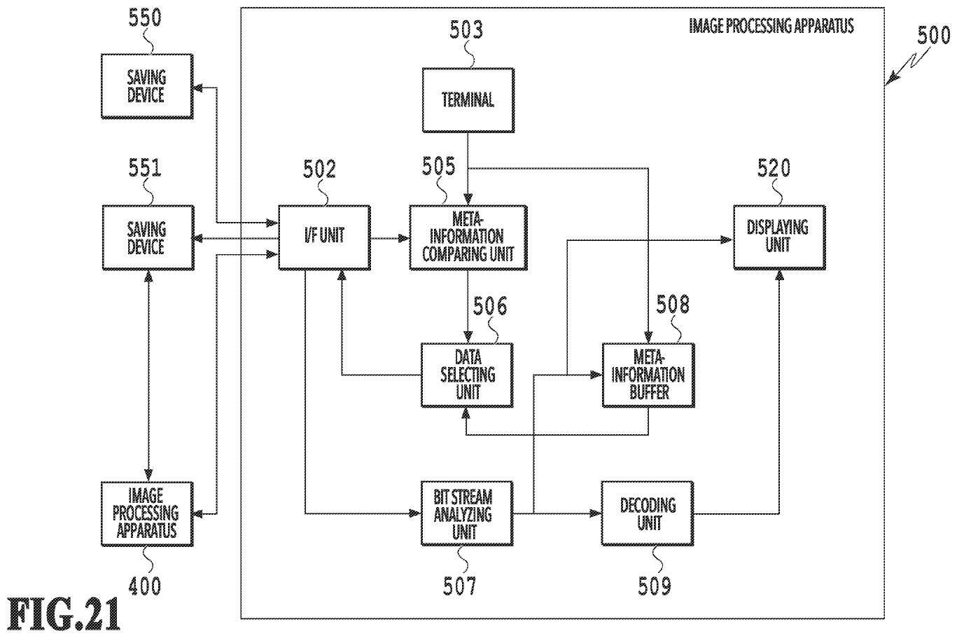

FIG. 21 illustrates a configuration example of a system including an image processing apparatus 500 in this embodiment. The image processing apparatus 500 is connected to an external saving device 550 and an external saving device 551. The saving device 550 stores the video file required for generating the virtual viewpoint video, as with the saving device 401 described in FIG. 8 in the second embodiment, for example. The saving device 551 stores the video file and the bit stream of the virtual viewpoint video like, for example, the saving unit 411 described in FIG. 8 in the second embodiment. In this embodiment, the virtual viewpoint video generated from the video file stored in the saving device 550 is described by using an example of the bit stream encoded by the H.265 encoding method.

The image processing apparatus 500 includes an interface (I/F) unit 502, a meta-information comparing unit 505, a data selecting unit 506, a bit stream analyzing unit 507, a meta-information buffer 508, a decoding unit 509, and a displaying unit 520. The image processing apparatus 500 reads out and displays a desired video file from the saving device 550 and also displays the virtual viewpoint video additionally.

A terminal 503 receives the input of the search condition (for example, keyword) related to the bit stream of the virtual viewpoint video from the user and outputs the search condition to the meta-information comparing unit 505.

Once the terminal 503 indicates that the searching is started, the I/F unit 502 reads out the header information and the meta-information of the bit stream from the saving device 551 and inputs the header information and the meta-information to the meta-information comparing unit 505. Additionally, there is included another bit stream encoded by the H.265 encoding method that is not generated in this embodiment.

The meta-information comparing unit 505 compares the meta-information inputted from the I/F unit 502 with the keyword inputted from the terminal 503. In a case where there is the meta-information that matches the keyword inputted from the terminal 503, the meta-information comparing unit 505 notifies the data selecting unit 506 of the information such as, for example, a datapath and the bit stream name, of the bit stream containing the meta-information.

Based on the notified bit stream information, the data selecting unit 506 selects the bit stream to be displayed and accesses the saving device 551 through the I/F unit 502. The saving device 551 reads out the target bit stream in response to the access. The read bit stream is inputted to the bit stream analyzing unit 507 through the I/F unit 502.

The bit stream analyzing unit 507 decodes and analyzes the header of the inputted bit stream, separates the meta-information from the header, and stores the meta-information into the meta-information buffer 508. Then, the bit stream analyzing unit 507 inputs the bit stream of the video data into the decoding unit 509. The decoding unit 509 decodes the inputted bit stream and inputs the bit stream to the displaying unit 520. Additionally, in a case where there are a multiple number of selected bit streams, the decoding unit 509 decodes each of the bit streams and inputs the bit streams to the displaying unit 520. The displaying unit 520 displays the decoded one or more bit streams.

Moreover, in a case where it is found out based on the separated meta-information that the video data is the virtual viewpoint video, the bit stream analyzing unit 507 notifies the displaying unit 520 of this fact. In response to the notification, the displaying unit 520 displays that the video being displayed is the virtual viewpoint video.

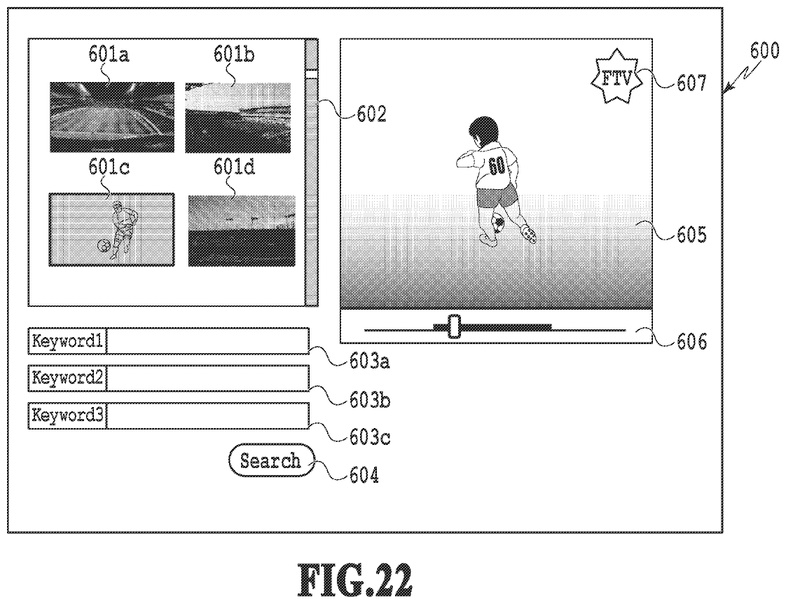

FIG. 22 illustrates a display screen of a displaying unit 520 in this embodiment. In a display screen 600, the user uses the terminal 503 to input the keyword as the search condition to keyword windows 603a to 603c, press a search button 604, and search for the video (bit stream).

The displaying unit 520 displays multiple videos 601a to 601d selected as the search result on a candidate window 602. Additionally, the displaying unit 520 displays one of the multiple videos displayed on the candidate window 602 that is selected by the user using the terminal 503 on a display window 605. The display window 605 includes a display bar 606. The display bar 606 indicates a part of the video that is the virtual viewpoint video with a bold line by the unit of frame. By the unit of stream, whether the video is the virtual viewpoint video can be determined by referring to existence or non-existence of the free_viewpoint_video_flag code in the VUI Parameters 902 or referring to the SEI_message 903. Additionally, by the unit of frame, it is possible to determine by referring to the value of the pic_free_viewpoint_info_flag code of the PPS 904.

In a case of reproducing the part of the video that is the virtual viewpoint video, the displaying unit 520 displays on the display window 605 a marker 607 that indicates that the video being displayed is the virtual viewpoint video. The marker 607 may be displayed for one of the multiple videos 601a to 610d in the candidate window 602 that includes the virtual viewpoint video.

As describe above, the image processing apparatus 500 in this embodiment can search for the bit stream based on the meta-information and display the search result.

Additionally, in the system including the image processing apparatus 500 in this embodiment, it is possible to regenerate the virtual viewpoint video by using the meta-information based on the video being displayed as the search result in response to the instruction by the user. The data selecting unit 506 reads out the meta-information corresponding to the video data from which the virtual viewpoint video is regenerated from the meta-information buffer 508. The data selecting unit 506 refers to the value of the free_viewpoint_original_video_info_flag code of the bit stream to determine whether there is the video data as the material of the generated virtual viewpoint video of the bit stream. As described above, in a case where the value of the free_viewpoint_original_video_info_flag code is 1, it is indicated that there is the video data as the material, and in a case where the value is 0, it is indicated that there is no video data as the material or that it is inaccessible to the video data. In a case where there is the video data, the space to which the video data is saved is identified by referring to the free_viewpoint_original_video_info_flag code and a pic_free_viewpoint_original_video_info code.

The data selecting unit 506 accesses the identified saving space of the saving device 550 through the I/F unit 502, reads out the video data as the material of the generated virtual viewpoint video, and inputs the video data to the image processing apparatus 400. The image processing apparatus 400 regenerates the virtual viewpoint video by using the inputted video data and inputs the virtual viewpoint video to the image processing apparatus 500 through the I/F unit 502. That is, the image processing apparatus 400 regenerates the virtual viewpoint video by using the video data inputted through the I/F unit 402 in FIG. 8. Additionally, the image processing apparatus 400 inputs the bit stream of the generated virtual viewpoint video to the I/F unit 502 in FIG. 21 through the output unit 410. The image processing apparatus 500 processes the inputted bit stream by the bit stream analyzing unit 507 and the decoding unit 509 and displays the bit stream on the displaying unit 520.

Note that, in the above-described embodiment, although the image processing apparatus 500 obtains the video data as the material and inputs the video data to the image processing apparatus 400, the image processing apparatus 500 may only notify the image processing apparatus 400 of the space to which the video data is saved. In this case, the image processing apparatus 400 can obtain the video data saved in the saving space and regenerate the virtual viewpoint video.

Thus, in the system including the image processing apparatus 500 in this embodiment, it is possible to regenerate the virtual viewpoint video based on the video being displayed as the search result.

As described above, according to this embodiment, it is possible to enable the virtual viewpoint video to be used as a common bit stream and to use at least one of the added shooting setting information, shooting right information, shooting target information, shooting condition information, and generation setting information for the searching. This makes it possible to efficiently search for the bit stream of the virtual viewpoint video by using the meta-information. Additionally, according to this embodiment, it is possible to regenerate the virtual viewpoint video from the video being displayed as the search result.

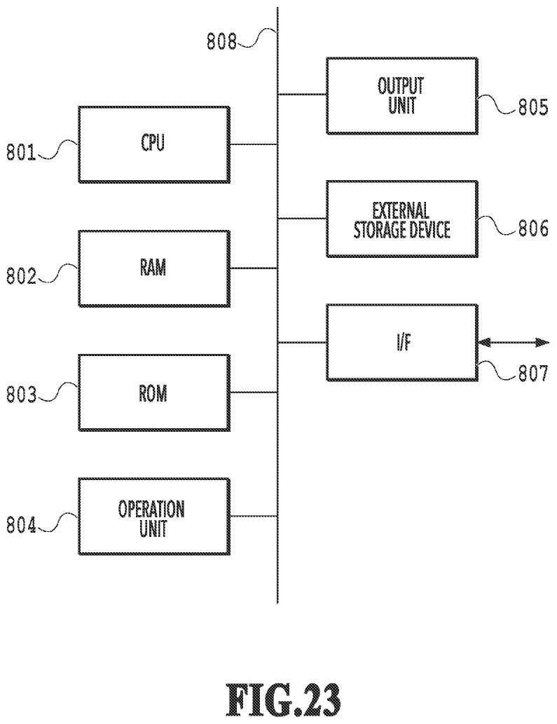

FIG. 23 is a block diagram illustrating a configuration example of hardware of a computer applicable to the image processing apparatus according to each of the above-described embodiments.

The CPU 801 uses computer programs and data stored in the RAM 802 and the ROM 803 to control overall the computer and also executes the processing of the image processing apparatus according to each of the above-described embodiments. That is, the CPU 801 functions as a processing unit for each of the above-described image processing apparatuses.

The RAM 802 includes an area for temporarily storing a computer program and data loaded from an external storage device 806 and data obtained from the outside through an I/F (interface) 807. Additionally, the RAM 802 includes a work area used while the CPU 801 executes the various kinds of processing. That is, the RAM 802 can be allocated as a frame memory for storing image data or can provide various other areas as needed, for example.

The ROM 803 stores setting data of the computer, a boot program, and the like. An operation unit 804 includes a keyboard, a mouse, and so on. The user can use the operation unit 804 to input various instructions to the computer. An output unit 805 displays the processing result by the CPU 801. The output unit 805 may be a liquid crystal display, for example.

The external storage device 806 is a large-capacity information storage device as represented by a hard disc drive device. The external storage device 806 saves an OS (operating system) and a computer program for implementing the functions of the processing units of the above-described image processing apparatus in the CPU 801. Additionally, the external storage device 806 may save image data as the processing target.

The computer program and the data saved in the external storage device 806 are loaded to the RAM 802 according to the control by the CPU 801 as needed and processed by the CPU 801. The I/F 807 is used to be connected to a network such as a LAN and the Internet and another device such as a projection device and a display device. The computer can obtain and transmit various kinds of information through the I/F 807. A bus 808 connects the above-described constituents of the computer mutually communicably.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Additionally, the codes indicating the meta-information described in the above-described embodiments may be used as data names. For example, it is possible to search for the data by making all the file names have a name in which several pieces of meta-information are linked by “_”. For example, the meta-information used for the data name may be filming_date_time_code, convention_name, event_name, stage_name, free_viewpoint_filming_info_code, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present embodiments, it is possible to facilitate the mutual utilization of video data for generating a virtual viewpoint video.

1. An image processing apparatus comprising:
an obtaining unit configured to obtain image data that is derived from at least one of captured images obtained by a plurality of image capturing devices and is used for generating a virtual viewpoint image; and
an adding unit configured to add at least one of image capturing setting information, image capturing condition information, image capturing target information, and image capturing right information to the image data obtained by the obtaining unit.

2. The image processing apparatus according to claim 1, wherein
the adding unit adds at least one of the image capturing setting information, the image capturing condition information, the image capturing target information, and the image capturing right information to each of frames included the image data obtained by the obtaining unit.

3. The image processing apparatus according to claim 1, wherein
the adding unit adds at least one of the image capturing setting information, the image capturing condition information, the image capturing target information, and the image capturing right information to each of a plurality of 3D models generated based on the image data obtained by the obtaining unit.

4. The image processing apparatus according to claim 1, wherein
the image capturing setting information includes at least one of information for specifying a place of the image capturing, information for specifying date and time of the image capturing, information for specifying an event, and information for specifying an image capturing device.

5. The image processing apparatus according to claim 4, wherein
the information for specifying an image capturing device includes at least one of information for specifying a position of a target point of each image capturing device, information for specifying the number of the image capturing devices, information for specifying an position of each image capturing device, information for specifying an orientation of each image capturing device, and information for specifying a focal length of each image capturing device.

6. The image processing apparatus according to claim 1, wherein
the image capturing condition information includes climate information during image capturing by the plurality of image capturing devices.

7. The image processing apparatus according to claim 1, wherein
the image capturing target information includes at least one of information for specifying a name of an image capturing target of the plurality of image capturing devices and information for specifying a name of an image capturing target group of the plurality of image capturing devices.

8. The image processing apparatus according to claim 1, wherein
the image capturing right information contains at least one of information for specifying a right holder related to the image capturing and information for specifying a right holder related to an image.

9. The image processing apparatus according to claim 1, wherein
the adding unit adds information to the image data by using ISO BMFF.

10. The image processing apparatus according to claim 1, wherein
the adding unit adds information to the image data by using Exif.

11. The image processing apparatus according to claim 1, wherein
the adding unit adds to a bit stream of the image data encoded by using an H.265 encoding method.

12. An image processing apparatus comprising:
an obtaining unit configured to obtain image data that is derived from at least one of captured images obtained by a plurality of image capturing devices and is associated with, as predetermined information, at least one of image capturing setting information, image capturing condition information, image capturing target information, and image capturing right information;
a generating unit configured to generate virtual viewpoint image data based on the image data obtained by the obtaining unit; and
an adding unit configured to add the predetermined-information to the virtual viewpoint image data generated by the generating unit.

13. The image processing apparatus according to claim 4, further comprising
a receiving unit configured to receive a search condition used for obtaining the image data, wherein
the obtaining unit obtain the image data associated with the predetermined information corresponding to the search condition received by the receiving unit.

14. An image processing method comprising the steps of:
obtaining image data that is derived from at least one of captured images obtained by a plurality of image capturing devices and is used for generating a virtual viewpoint image; and
adding at least one of image capturing setting information, image capturing condition information, image capturing target information, and image capturing right information to the image data obtained in the step of obtaining.

15. An image processing method comprising the steps of:
obtaining image data that is derived from at least one of captured images obtained by a plurality of image capturing devices and is associated with, as predetermined information, at least one of image capturing setting information, image capturing condition information, image capturing target information, and image capturing right information;
generating virtual viewpoint image data based on the image data obtained in the step of obtaining; and
adding the predetermined-information to the virtual viewpoint image data generated in the step of generating.

16. A non-transitory computer-readable storage medium storing a program for causing a computer to function as an image processing apparatus, the non-transitory computer-readable storage medium comprising:
an obtaining unit configured to obtain image data that is derived from at least one of captured images obtained by a plurality of image capturing devices and is used for generating a virtual viewpoint image; and
an adding unit configured to add at least one of image capturing setting information, image capturing condition information, image capturing target information, and image capturing right information to the image data obtained by the obtaining unit.
